(19) United States
(12) Patent Application Publication
(10) Pub. No.: US 2017/0363129 A1
(43) Pub. Date: Dec. 21, 2017

(54) CONNECTING ELEMENT, IN PARTICULAR A BOLT OR A NUT, PREFERABLY FOR FASTENING A WHEEL, OR RIM, TO A HUB OF A VEHICLE

(71) Applicant: BIMECC ENGINEERING S.p.A., Veggiano (Padova) (IT)

(72) Inventor: Ferdinando BADA, MESTRINO (PADOVA) (IT)

(21) Appl. No.: 15/280,287

(22) Filed: Sep. 29, 2016

(30) Foreign Application Priority Data
Jun. 16, 2016 (IT) 102016000062233

(51) Int. Cl. F16B 23/00; B60B 29/00; B25B 13/06; B60B 27/06

(52) U.S. Cl. CPC F16B 23/003; B60B 27/065; B60B 29/003; B25B 13/065; B60B 2900/212; B60B 2900/541; B60B 2340/50

(57) ABSTRACT

A connecting element, preferably for fastening a wheel, or rim, to a hub of a vehicle, includes a body having a respective outer perimeter surface which extends along a respective imaginary profile, in particular an imaginary circular profile, there being formed, at the perimeter surface, respective elements for the engagement of corresponding elements or tool for screwing and/or unscrewing the connecting element, and screw thread elements for fastening, preferably to the vehicle hub. The engagement elements include a plurality of perpendicularly extending and circumferentially distributed engagement troughs which are recessed relative to the imaginary outer profile and each being separated from the adjacent trough by a respective outer perimeter transit zone. The outer transit zone has a width (r) which is less than the width (i) of the trough, and in particular, a width (r) which is less than half the width of the trough.

### BACKGROUND OF THE INVENTION

This invention relates to a connecting element, in particular a bolt or a nut, preferably for fastening a wheel, or rim, to a hub of a vehicle, especially of a motor vehicle such as a motor car.

Known in the prior art are bolts or nuts for fastening a wheel, or rim, to a hub of a vehicle, especially of motor car. These bolts or nuts comprise a body having a respective outer perimeter surface, which extends along a respective imaginary profile, in particular an imaginary circular profile, there being formed, at the perimeter surface, respective means for the engagement of corresponding means or tool for screwing and/or unscrewing the bolt or nut.

The engagement means of the prior art bolts or nuts comprise a plurality of perpendicularly extending and circumferentially distributed engagement troughs, these engagement troughs being recessed relative to the imaginary outer profile and each being separated from the adjacent trough by a respective outer perimeter transit zone.

In these prior art bolts and nuts, however, the outer transit zone is very large and this, although it allows easily applying the screwing/unscrewing tool, defines an overall engagement surface which is relatively reduced in size for applying screwing force, with the risk of easily damaging the bolt or nut or the screwing tool and thus preventing fastening operations from being carried out, with all the time-wasting inconveniences that this creates.

Another problem with prior art connecting nuts and bolts is due to the size of the tools needed to screw and unscrew them. Such tools normally have an excessively cumbersome head which requires a relatively large amount of material for its production and which is, moreover, excessively heavy.

Another problem with connecting nuts in particular is the method used for their production up to now. In effect, these nuts are made from a tube-like part with a central through hole which is internally tapped and to which a cap is applied, in particular by electric welding, thus closing the threaded hole at one end. Over time, however, the electrically welded joint is attacked by rust which can eventually lead to the cap snapping off the body of the nut.

The industry in any case feels the need for connecting elements and respective screwing tools which, in use, require only a limited amount of force.

Another need felt by the industry is that for connecting elements and respective screwing tools which allow screwing/unscrewing torque to be effectively transmitted.

A yet further need felt by the industry is that for connecting elements and respective screwing tools which allow preventing or reducing the risk of stripping the screw threads.

### SUMMARY OF THE INVENTION

This invention therefore proposes a new solution as an alternative to the solutions known up to now and, more specifically, proposes to overcome one or more of the above mentioned drawbacks or problems and/or to meet one or more of the needs felt by the trade and which, in particular, may be inferred from the above.

This invention accordingly provides a connecting element, in particular a bolt or a nut, preferably for fastening a wheel, or rim, to a hub of a vehicle, especially of a motor vehicle such as a motor car; comprising a body having an outer perimeter surface which extends along a respective imaginary profile, in particular an imaginary circular profile, there being formed, at the perimeter surface, respective means for the engagement of corresponding means or tool for screwing and/or unscrewing the connecting element; and screw thread means for fastening, preferably to the vehicle hub; the engagement means comprising a plurality of perpendicularly extending and circumferentially distributed engagement troughs, these engagement troughs being recessed relative to the imaginary outer profile and each being separated from the adjacent trough by a respective perimetrically extending transit zone; characterized in that the width of the transit zone between adjacent engagement troughs is less than the width of the respective trough, in particular the width of the transit zone being less than half the width of the trough, and more particularly, the width of the outer transit zone being less than a quarter of the width of the trough; the width of the transit zone being preferably less than a sixth of the width of the trough and still more preferably, the width of the transit zone being less than a seventh of the width of the trough itself.

This advantageously allows the corresponding screwing and unscrewing force to be distributed on a larger surface, thereby preventing damage to the connecting element and/or to the corresponding screwing tool.

The invention also provides a connecting element, in particular a bolt or a nut, preferably for fastening a wheel, or rim, to a hub of a vehicle, especially of a motor vehicle such as a motor car; comprising a body having an outer perimeter surface which extends along a respective imaginary profile, in particular an imaginary circular profile, there being formed, at the perimeter surface, respective means for the engagement of corresponding means or tool for screwing and/or unscrewing the connecting element; and screw thread means for fastening, preferably to the vehicle hub; the engagement means comprise a plurality of perpendicularly extending and circumferentially distributed engagement troughs, these engagement troughs being recessed relative to the imaginary outer profile and each being separated from the adjacent trough by a respective perimetrically extending transit zone; characterized in that the engagement means comprise seven or more engagement troughs, in particular between eight and fourteen troughs, more particularly between eight and twelve troughs and, preferably, ten troughs.

This advantageously allows the corresponding screwing and unscrewing force to be distributed on a larger surface, thereby preventing damage to the connecting element and/or to the corresponding screwing tool.

According to another aspect, this invention provides a tool or spanner for the screwing and unscrewing of connecting elements, in particular of a bolt or a nut, preferably for fastening a wheel, or rim, to a hub of a vehicle, especially of a motor vehicle such as a motor car; comprising a body having respective means for engaging corresponding engagement means of the connecting element; and engagement means for actuating the tool in rotation; the engagement means comprising a plurality of perpendicularly extending and circumferentially distributed engagement troughs, these engagement troughs projecting inwards towards the center of the tool, starting from a corresponding imaginary bottom profile and each being separated from the adjacent trough by a respective perimetrically extending transit zone; characterized in that the width of the transit zone between adjacent internally protruding engagement troughs is less than the width of the respective trough, in particular the width of the transit zone being less than half the width of the trough, and more particularly, the width of the outer transit zone being less than a quarter of the width of the trough; the width of the transit zone being preferably less than a sixth of the width of the trough and still more preferably, the width of the transit zone being less than a seventh of the width of the trough itself.

This advantageously provides a tool which allows the corresponding screwing and unscrewing force to be distributed on a larger surface, thereby preventing damage to the screwing tool and/or to the corresponding connecting element.

According to another aspect, this invention provides a tool or spanner for the screwing and unscrewing of connecting elements, in particular of a bolt or a nut, preferably for fastening a wheel, or rim, to a hub of a vehicle, especially of a motor vehicle such as a motor car; comprising a body having respective means for engaging corresponding engagement means of the connecting element; and engagement means for actuating the tool in rotation; the engagement means comprising a plurality of perpendicularly extending and circumferentially distributed engagement troughs, these engagement troughs projecting inwards towards the center of the tool, starting from a corresponding imaginary bottom profile and each being separated from the adjacent trough by a respective perimetrically extending transit zone; characterized in that the engagement means comprise seven or more internally protruding engagement troughs, in particular between eight and fourteen internally protruding troughs, more particularly between eight and twelve internally protruding troughs and, preferably, ten internally protruding troughs.

This advantageously provides a tool which allows the corresponding screwing and unscrewing force to be distributed on a larger surface, thereby preventing damage to the screwing tool and/or to the corresponding connecting element.

### BRIEF DESCRIPTION OF THE DRAWINGS

This and other innovative aspects, or specific advantageous embodiments, are set out in the appended claims and the technical features are apparent from the detailed description which follows of a preferred, advantageous embodiment which must, however, be considered purely as a non-limiting example of the invention, the description being made with reference to the accompanying drawings, in which:

FIG. 1 is a perspective view of a first preferred embodiment of a connecting element according to this invention;

FIG. 2A is a side view of the first preferred embodiment of the element according to the invention;

FIG. 2B shows an enlarged detail from FIG. 2A;

FIG. 3 is a top plan view of the first preferred embodiment of the element according to the invention;

FIG. 3A is an enlarged view of a detail from FIG. 3;

FIG. 3B shows an enlarged detail from FIG. 3;

FIG. 4 is a cross section, through line IV-IV of FIG. 2A, of the first preferred embodiment of the element according to the invention;

FIG. 5 is a side view of a second preferred embodiment of the element according to this invention;

FIG. 6 is a top plan view of the second preferred embodiment of the element according to the invention;

FIG. 7 is a cross section, through line VII-VII of FIG. 6, of the second preferred embodiment of the element according to the invention;

FIG. 8 is a side view of a third preferred embodiment of the element according to this invention;

FIG. 9 is a top plan view of the third preferred embodiment of the element according to the invention;

FIG. 10 is a cross section, through line X-X of FIG. 8, of the third preferred embodiment of the element according to the invention;

FIG. 11 is a side view of a preferred embodiment of a tool for screwing and unscrewing connecting elements;

FIG. 12 is a cross section through line XII-XII of FIG. 11;

FIG. 12 is a top plan view of the preferred embodiment of the tool for screwing and unscrewing connecting elements;

FIG. 13 is a bottom plan view of the preferred embodiment of the tool for screwing and unscrewing connecting elements;

FIG. 13A is an enlarged view of a detail from FIG. 13;

FIG. 14 is a cross section, through line XIV- XIV of FIG. 11, of the preferred embodiment of the tool for screwing and unscrewing connecting elements.

### DESCRIPTION OF THE PREFERRED EMBODIMENTS

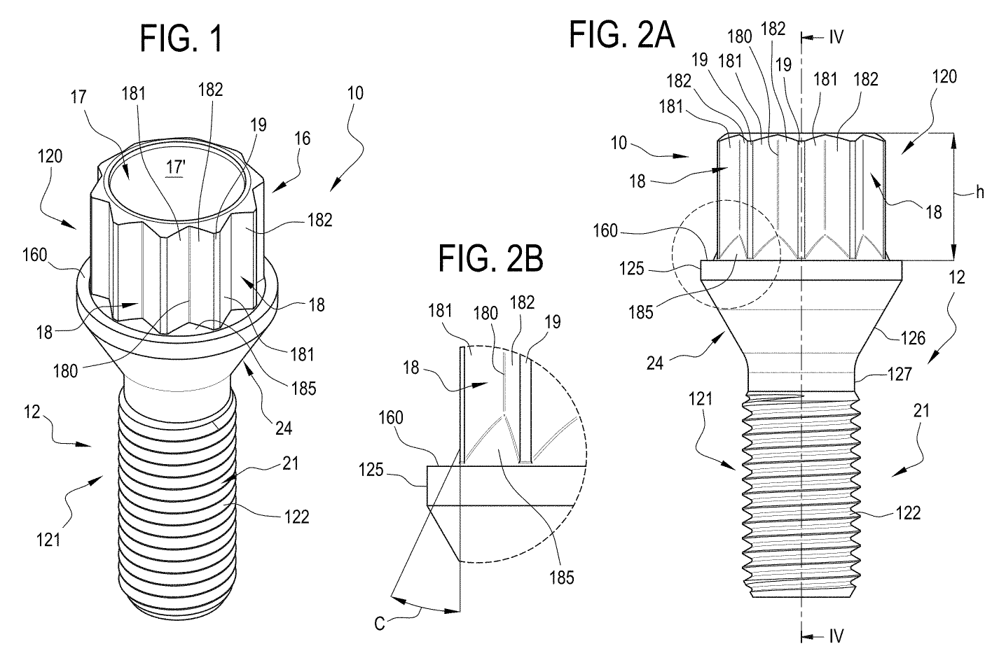

FIGS. 1 to 4 illustrate a first preferred embodiment 10 of a connecting element, in particular in the form of a bolt, used preferably for fastening a wheel, or rim, to a hub of a vehicle, especially of a motor vehicle such as a motor car.

As illustrated, the element. or bolt 10 comprises a body having a respective outer perimeter surface 14 which extends along a respective imaginary profile, in particular an imaginary circular profile, there being formed, at the perimeter surface, respective means 16 for the engagement of corresponding means or tool for screwing and/or unscrewing the connecting element.

As illustrated, the body 12 of the element or bolt 10 also comprises screw thread means 21 for fastening the bolt or element 10 preferably to the vehicle hub

As illustrated, the above mentioned engagement means 16 comprise a plurality of perpendicularly extending and circumferentially distributed engagement troughs 18, these engagement troughs 18 being recessed in the body of the connecting element relative to the imaginary outer profile 14 and each being separated from the adjacent trough 18 by a respective perimetrically extending outer transit zone or face 19.

In practice, as illustrated, the engagement means 16 comprise a plurality of engagement troughs 18 and a plurality of perimeter transit zones 19 alternated, or interposed between, adjacent engagement troughs 18, 18.

In particular, as may be inferred from the drawings, the engagement troughs 18 are equal in size.

Further, as may be inferred from the drawings, the transit zones 19 between adjacent engagement troughs 18 are equal in size.

Advantageously, as illustrated, the respective engagement trough 18 comprises a first face 181 and a second face 182 opposite each other, for engaging a corresponding surface, or trough, of the screwing and/or unscrewing means, the engagement faces 181, 182 being recessed relative to the outer profile 14 and converging towards and at a respective radially inner zone 180 of common convergence of the self-same faces 181, 182 of the trough 18.

As illustrated, the respective face 181, 182 of the respective trough 18 is divided, or separated, from the face 181, 182 of the adjacent trough 18 of the engagement means 16 through the outer, perimetrically extending transit zone 19.

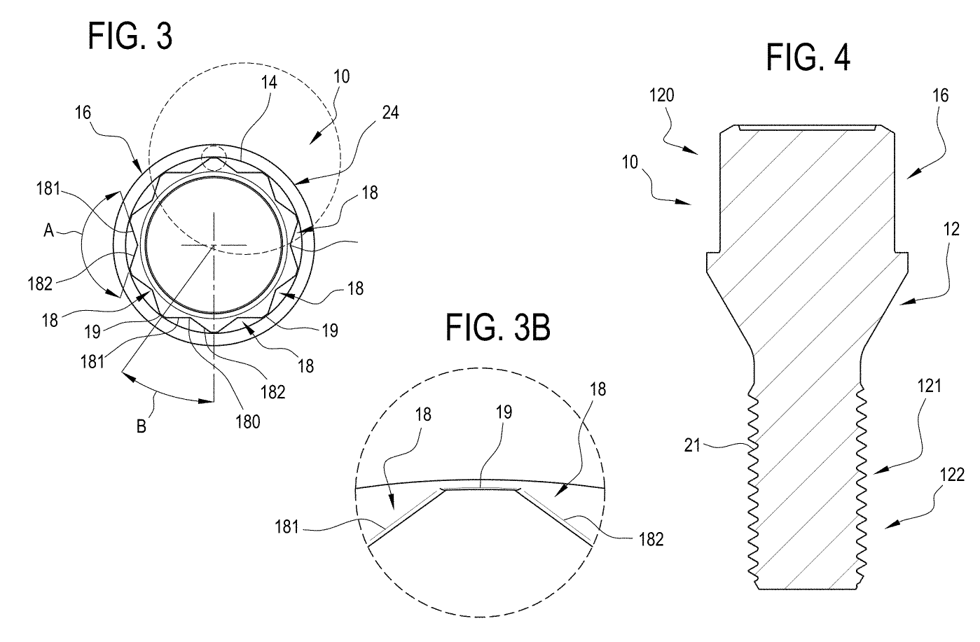

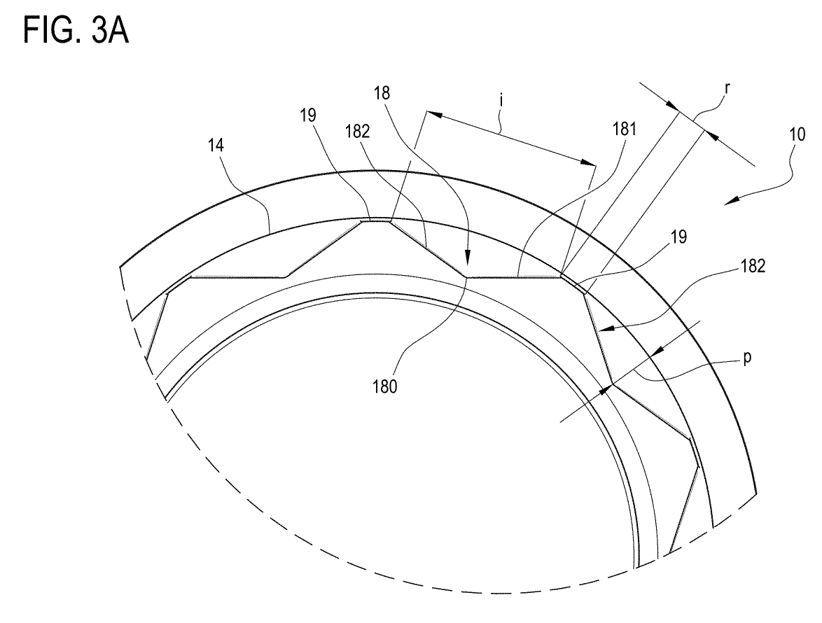

As may be inferred in particular from FIG. 3A, the respective engagement trough 18 has a respective width “i”, which is the distance between opposite end points of the trough 18, from which extend the respective transit zones, or faces 19 on each side of the engagement trough 18.

As may be inferred in particular from FIG. 3A, the outer transit zone 19 has a respective width “r”, which is the distance between opposite ends of the zone, or face, 19, from which extend the respective faces 181, 182 of the adjacent engagement troughs 18, 18.

Advantageously, the outer transit zone 19 has a width “r” which is less than the width “i” of the trough. Further advantageously, the outer transit zone 19 has a width “r” which is less than half the width i of the trough 18.

Yet further advantageously, the outer transit zone 19 has a width “r” which is less than a quarter of the width “i” of the trough 18.

This advantageously allows the corresponding screwing and unscrewing force to be distributed on a larger surface, thereby preventing damage to the connecting element and/or to the corresponding screwing tool.

Further advantageously, the outer transit zone 19 has a width “r” which is preferably less than a sixth of the width “i” of the engagement trough 18 and, still more preferably, the outer transit zone 19 has a width “r” which is preferably less than a seventh of the width “i” of the trough 18.

Thus obtained is a connecting element which allows producing a low stress level and effectively transmitting the screwing and/or unscrewing torque, while at the same time preventing or reducing the risk of the tool slipping on the corresponding engagement zone of the connecting element.

Further advantageously, moreover, the outer transit zone 19 has a width “r” which is greater than a tenth of the width “i” of the trough 18.

Further advantageously, the outer transit zone 19 has a width “r” which is in any case greater than 0.6 mm.

Advantageously, the engagement means 16 comprise seven or more engagement troughs 18, in particular between eight and fourteen troughs, more particularly between eight and twelve troughs.

This advantageously allows the corresponding screwing and unscrewing force to be distributed on a larger surface, thereby preventing damage to the connecting element and/or to the corresponding screwing tool.

Advantageously, as illustrated and particularly preferably, the engagement means 16 comprise ten troughs 18.

Thus obtained is a connecting element which allows producing a low stress level and effectively transmitting the screwing and/or unscrewing torque, while at the same time preventing or reducing the risk of the tool slipping on the corresponding engagement zone of the connecting element.

Advantageously, the respective trough 18 has a maximum radial thickness, or maximum depth “p”, which is measured between the radially inner point or zone 180 of common convergence of the faces 181, 182 of the trough 18 and the imaginary profile 14, the radial thickness, or maximum depth “p” of the trough being between 0.5 mm and 2 mm, in particular between 0.6 mm and 2 mm, and preferably between 0.8 mm and 2 mm.

Thus, the connecting element can be provided with engagement means which are particularly limited in size.

Advantageously, as may be inferred from the corresponding drawings, the respective face 181, 182 of the engagement trough 18 of the connecting element is flat and extends perpendicularly, in particular extending perpendicularly for a distance greater than at least ten times the width of the engagement face itself.

In particular, as may be inferred from the drawings, the first and second opposite engagement faces 181 and 182 of the respective trough are equal in size.

Advantageously, as may be inferred from FIG. 3, the faces 181, 182 of each trough are angularly spaced from each other by an angle A of between 135° and 154°, in particular between 135° and 150° and, preferably, an angle A equal to or around 144°.

Thus obtained is a connecting element which allows producing a low stress level and effectively transmitting the screwing and/or unscrewing torque, while at the same time having a limited radial dimension.

Advantageously, the zone of common convergence 180 of the engagement faces 181, 182 of the trough 180 is defined by a linear, perpendicular transit stretch 180 which is, in particular, particularly thin since it consists of plain, minimum transit radiusing between the engagement faces 181, 182. The transit radiusing preferably has a curvature radius of around 0.2 mm.

Advantageously, the respective outer transit zone 19 between adjacent troughs 18 has a large circular profile which corresponds to the imaginary outer profile 14 of the engagement means 16.

In practice, in the embodiments described here, the transit zones 19 which are adjacent to each other, that is, which are separated by a trough 18, are angularly spaced, that is, the respective midpoint is angularly spaced by an angle B which is equal to 36° relative to the center of the element 10 itself. Obviously, in other preferred embodiments, for example an embodiment having 8 troughs, the angle B would be 45°, or in an embodiment having twelve troughs, the angle B would be 30°.

Advantageously, the height h of the engagement means 16 or of the engagement troughs 18 is greater than the diameter of the outer imaginary perimeter 14 of the engagement means 16 themselves, in particular greater than twice the diameter.

In particular, as illustrated, the element, or bolt 10 comprises a shank 121 which extends from the head 120 of the element, or bolt 10, the shank having, along at least part of its peripheral profile, a corresponding thread 122.

Advantageously, on the side of the head or part 120 of the body of the element which defines the engagement surface 16), there extends perpendicularly an extension block 24 whose outer profile extends on the outside of the outer profile of the engagement means 16, that is, outside the imaginary outer perimeter 14 thereof.

Advantageously, the extension block 24 has a cylindrical portion 125 which is adjacent to the zone defining the engagement means 16 and from which a portion 126 with a conical outside surface extends perpendicularly.

Advantageously, at the base of the engagement means or surface 16 there extends a transverse surface 160 which in particular defines means for stopping the screwing and/or unscrewing tool at the correct position on the connecting element.

In particular, as illustrated. the extension block 24 is longitudinally delimited by a transverse surface 160 at the base of the engagement means or surface 16.

In particular, as illustrated, a cylindrical collar 127, or first part of the shank 121, extends from the conical portion of the extension block 24.

In particular, as illustrated, the threaded shank 121 of the element or bolt 10 extends from the extension block 24, in particular defining, with the respective non-threaded end, the end collar 127 which extends from the conical part 126 of the extension block 24.

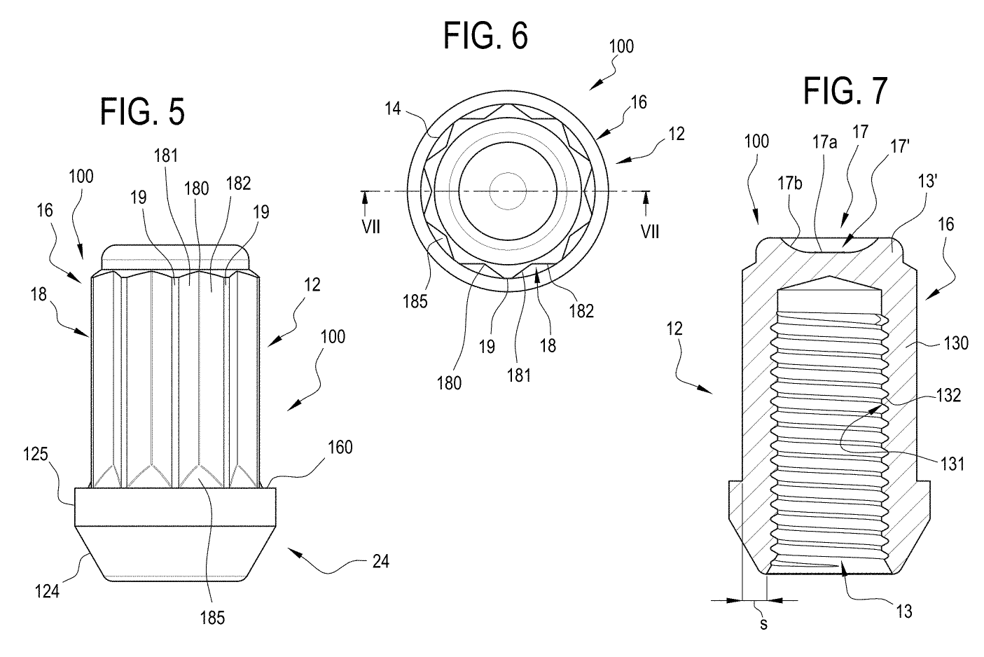

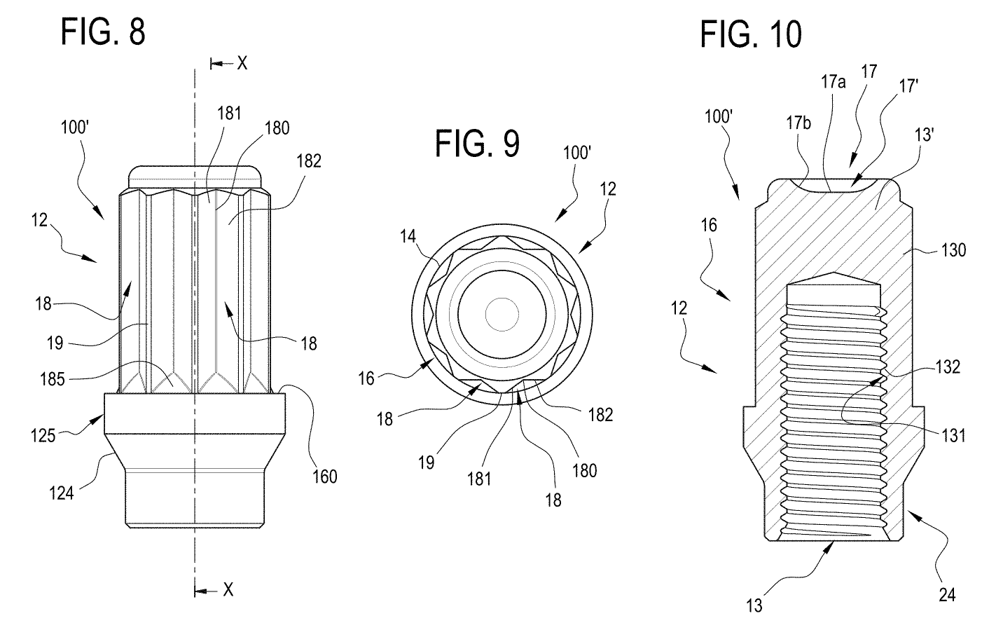

Advantageously, according to a second and a third preferred embodiment 100, 100′ of the element, in the form of respective nuts, illustrated in FIGS. 5 to 10, the body 12 of the element 100, 100′ has an internal cavity 13 delimited by a perimeter wall 130 of the body 12 of the element, the inside surface of which 131 is provided with a respective thread 132.

Advantageously, as may be inferred from FIG. 7, according to these further preferred embodiments 100 and 100′, the radial thickness s of the hollow body 12, between the radially inner zone 180 of common convergence of the faces 181, 182 of the trough 18 and the bottom of the thread 131, is between 1.5 mm and 2.5 mm, preferably equal to or around 2 mm.

Thus, the connecting nuts can be provided with engagement means which are at once limited in size and advantageously resistant.

In particular, as illustrated, according to these further preferred embodiments 100 and 100′, the internal cavity 13 is blind, that is to say, it extends perpendicularly between an open end and a transverse closed end wall 13′.

Advantageously, according to the second and third preferred embodiments of the element, the transverse closed end wall 13′ is made as one piece with the side wall 13 of the body 12 of the element or nut, that is to say, with the other parts of the nut body, the nut body 12 being in particular made by cold forming a respective semi-finished block.

In particular, further advantageously, as illustrated, the transverse end face 17 of the body of the element 10, 100, 100′ has a large central recess 17′, which preferably, in the second and third preferred embodiments, has a concave peripheral edge 17b and a preferably flat bottom 17a.

In particular, as illustrated, in all of the above mentioned preferred embodiments of the connecting element 10, 100 and 100, the respective trough 18 is delimited at the bottom by a bottom end surface 185 connected to the transverse reference or stopping surface 160, the end surface, in particular the end surface of the trough is preferably a planar surface in the form of an inclined surface.

More specifically, the end surface 185 is inclined at an angle C of between 20° and 35° to the direction parallel to the axis of the element, and, in particular, preferably at an angle C of between 25° and 30°.

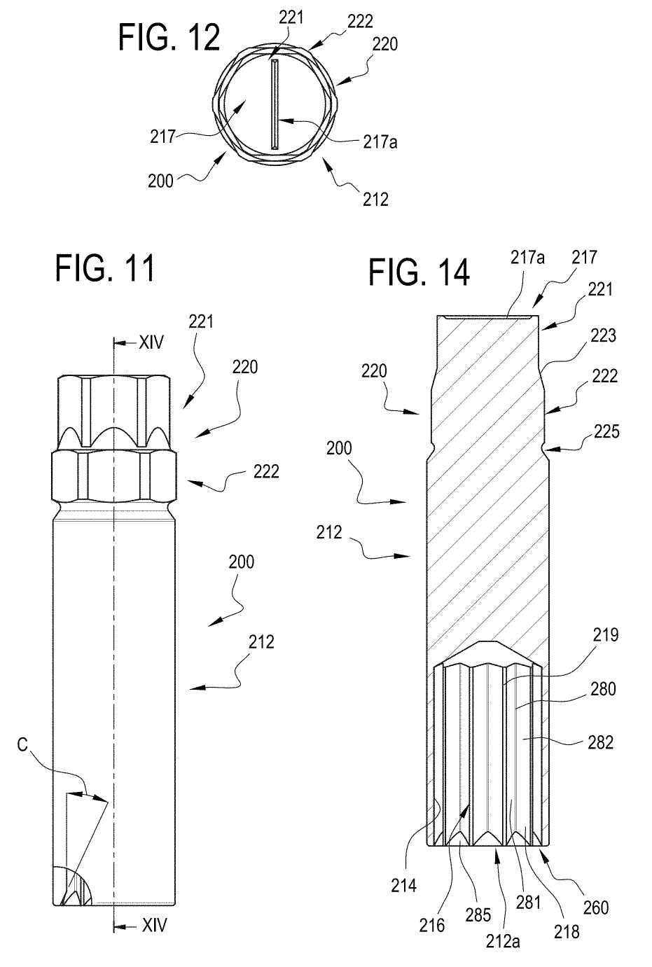

FIGS. 11 to 14 illustrate a preferred embodiment of a tool or spanner 200 for the screwing and unscrewing of connecting elements, in particular of a bolt or a nut, preferably for fastening a wheel, or rim, to a hub of a vehicle, especially of a motor vehicle such as a motor car, and particularly suitable for application to the connecting element of the preferred embodiments described above.

The screwing or unscrewing tool 200 comprises, as illustrated, a body 212 having a respective outer perimeter surface which extends along a respective imaginary profile 214, in particular an imaginary circular profile.

The body 212 also comprises respective means 216 for engaging corresponding engagement means 16 of the connecting element.

As illustrated, the tool 200 further comprises engagement means 220 for actuating the tool in rotation.

As may be inferred from the drawings, the engagement means 216 comprise a plurality of perpendicularly extending and circumferentially distributed engagement troughs 218, these engagement troughs 218 projecting inwards towards the center of the body 212 of the tool, starting from a corresponding imaginary bottom profile 214 and each trough 218 being separated from the adjacent trough 218 by a respective perimetrically extending transit zone 219 at the imaginary bottom profile 214.

In practice, as illustrated, the engagement means 216 of the tool or spanner 200 comprise a plurality of engagement troughs 218 and a plurality of perimeter transit zones 219 alternated, or interposed between, adjacent engagement troughs 218, 218.

In particular, as may be inferred from the drawings, the engagement troughs 218 are equal in size.

Further, as may be inferred from the drawings, the transit zones 219 between adjacent engagement troughs 218 are equal in size.

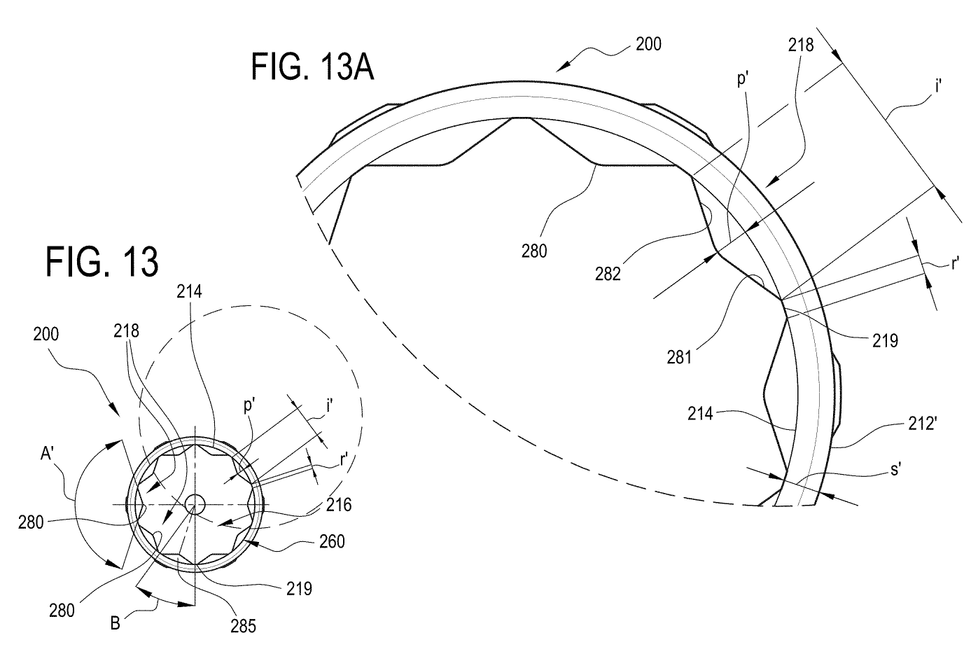

As may be inferred in particular from FIG. 13, the respective engagement trough 218 has a respective width i′, which is the distance between opposite end points of the trough 218, from which extend the respective transit zones, or faces 219 on each side of the engagement trough 218.

As may be inferred in particular from FIG. 13, the inner transit zone 219 has a respective width r′, which is the distance between opposite ends of the zone, or face, 219, from which extend the respective faces 281, 282 of the adjacent engagement troughs 218.

Advantageously, the width r′ of the transit zone 219 is less than the width i′ of the trough 218, in particular the width r′ of the transit zone 219 being less than half the width i′ of the trough 218, and more particularly, the width r′ of the transit zone 219 being less than a quarter of the width i′ of the trough 218.

This advantageously provides a tool which allows the corresponding screwing and unscrewing force to be distributed on a larger surface, thereby preventing damage to the screwing tool and/or to the corresponding connecting element.

More preferably, the width r′ of the transit zone 219 is less than a sixth of the width i′ of the trough 218 and still more preferably, the width r′ of the transit zone 219 is less than a seventh of the width i′ of the trough 218.

Thus obtained is a screwing and unscrewing tool which allows producing a low stress level and effectively transmitting the screwing and/or unscrewing torque, while at the same time preventing or reducing the risk of the tool slipping on the corresponding engagement zone of the connecting element.

Advantageously, the inner transit zone 219 has a width r′ which is greater than a tenth of the width i′ of the trough 218.

Advantageously, the inner or bottom transit zone 219 has a width r′ which is greater than 0.6 mm.

Advantageously, as illustrated, the tool 200 comprises a respective tool body 212 which is, in particular in the form of an elongate shank extending along a respective longitudinal axis.

In particular, as illustrated, the tool body 212 has a hollow, axially open end 212a for gripping the element, in particular the bolt or nut, to be screwed and/or unscrewed, the internal cavity 212a being delimited by an imaginary inside surface 214 where the engagement means 216 are provided.

Advantageously, the means 220 for actuating the tool are provided at the end opposite the end with the engagement means 216.

In particular, advantageously, the actuating means 220 are in the form of a shape fitting 221 or 222 for a respective spanner or actuating tool.

In particular, as illustrated, the actuating means 220 comprise a first shape fitting 221 and a second shape fitting 222 for respective spanners or actuating tools and which are, in particular, longitudinally aligned and close together.

Advantageously, the respective engagement trough comprises a first face 281 and a second face 282 opposite each other, for engaging a corresponding surface of the connecting element 10 or 100, the engagement faces 281, 282 projecting inwards relative to the imaginary bottom profile 214 of the engagement means 216 and converging towards and at a respective radially inner zone 280 of common convergence of the self-same faces 281, 282 of the trough 218.

As illustrated, the respective face 281, 282 of the respective trough 218 is separated from the respective face 281, 282 of the adjacent trough 218 of the engagement means 216 through the inner or bottom perimeter transit zone 219.

Advantageously, the engagement means 216 comprise seven or more inwardly protruding engagement troughs 218, in particular between eight and fourteen inwardly protruding troughs 218, more particularly between eight and twelve inwardly protruding troughs 218 and, preferably, ten inwardly protruding troughs 218.

Advantageously, the respective trough 218 has a maximum radial thickness p′ which is between 0.5 mm and 2 mm, in particular between 0.6 mm and 2 mm, and preferably between 0.8 mm and 2 mm.

Advantageously, the respective face 281, 282 of the engagement trough 218 is flat and extends perpendicularly, in particular extending perpendicularly for a distance greater than at least ten times the width of the engagement face itself.

Advantageously, the first and second opposite engagement faces 281 and 282 of the respective inwardly protruding trough 218 are equal in size.

Advantageously, the faces 281, 282 of each inwardly protruding trough are angularly spaced from each other by an angle A of between 135° and 154°, in particular between 135° and 150° and, preferably, an angle A equal to or around 144°.

Advantageously, the zone of common convergence 280 of the engagement faces 281, 282 of the inwardly protruding trough 280 is defined by a linear, perpendicular transit stretch 280.

In particular, as illustrated, the respective bottom transit zone 219 between adjacent inwardly protruding troughs 218 has a large circular profile.

In practice, in this preferred embodiment, the transit zones 219 which are adjacent to each other are angularly spaced, that is, the respective midpoint is spaced by an angle B which is equal to 36°.

Advantageously, the height of the engagement means 216 of the tool or the height of the inwardly protruding engagement troughs 218 is greater than the diameter of the imaginary perimeter of the engagement means 216 themselves, in particular greater than twice the diameter.

Advantageously, at the base of the engagement means or surface 216 of the tool there is a perimetrically extending or internally hollow transverse surface 260 which, in particular, defines means for stopping the insertion of the screwing and/or unscrewing tool into the corresponding connecting element.

Advantageously, the respective inwardly protruding trough 218 is delimited at the bottom by a bottom end surface 285 connected to the transverse reference or stopping surface 260, the end surface of the inwardly protruding trough being in particular in the form of a planar surface, in particular an inclined surface, and more particularly, inclined at an angle C of between 20° and 35° relative to the direction parallel to the axis of the connecting element, and preferably inclined at an angle C of between 25° and 30°.

Advantageously, the first actuating shape fitting (221) is longitudinally offset from the second shape fitting 222 and is smaller or slightly smaller in width or diameter than the second shape fitting 222.

In particular, as illustrated, the first actuating shape fitting 221 is separated from the second shape fitting 222 by a corresponding peripheral profile 223, in particular conical, converging towards the self-same first, outer actuating shape fitting 221.

In particular, as illustrated, the actuating means 220 are separated from the shank body 212 by a respective perimeter recess 225, in particular made just under the second actuating shape fitting 222.

Advantageously, as may be inferred, the transverse end face 217 of the body 212 of the tool has a large central recess 217′, which preferably has flat bottom 217a.

Advantageously, the radial thickness s′ of the hollow body 12 of the tool, between the outside surface 212′ and the bottom 214 of the respective engagement means 216, is between 1 mm and 1.8 mm, and preferably between 1.2 mm and 1.5 mm.

In practice, as is evident, the technical features described above, individually or in combination, allow this invention to achieve at least one or more of the following advantageous results:
providing an element or tool which works in a particularly effective manner;
preventing damage to the connecting element and/or to the corresponding screwing tool;
guaranteeing that the screwing or unscrewing tool has an effective grip on the connecting element;
providing connecting elements and respective screwing tools which, in use, require only a limited amount of force;
providing connecting elements and respective screwing tools which allow screwing/unscrewing torque to be effectively transmitted;
providing screwing tools which are not excessively cumbersome and/or whose production does not require a large amount of material and which, moreover, are not excessively heavy in weight.

The invention described is susceptible of industrial application. It would be obvious to one skilled in the art that several changes and modifications can be made to the invention without departing from the spirit and scope of the invention, described in depth above. Also, further preferred embodiments of the invention comprising one or more of the features described herein can easily be imagined. It will also be understood that all the details of the invention may be replaced by technically equivalent elements.

1) A connecting element (10, 100, 100′), in particular a bolt or a nut, preferably for fastening a wheel, or rim, to a hub of a vehicle, especially of a motor vehicle such as a motor car; comprising a body (12) having a respective outer perimeter surface (14) which extends along a respective imaginary profile, in particular an imaginary circular profile, there being formed, at the perimeter surface, respective means (16) for the engagement of corresponding means or tool (200) for screwing and/or unscrewing the connecting element; and screw thread means (21) for fastening, preferably to the vehicle hub; the engagement means (16) comprising a plurality of perpendicularly extending and circumferentially distributed engagement troughs (18), these engagement troughs being recessed relative to the imaginary outer profile and each being separated from the adjacent trough (18) by a respective perimetrically extending outer transit zone (19); wherein the width (r) of the transit zone (19) between adjacent engagement troughs (18, 18) is less than the width (i) of the respective trough (18), in particular the width (r) of the outer transit zone (19) being less than half the width (i) of the trough (18), and more particularly, the width (r) of the outer transit zone being less than a quarter of the width (i) of the trough (18); the width (r) of the transit zone (19) being preferably less than a sixth of the width (i) of the trough (18) and still more preferably, the width (r) of the transit zone (18) being less than a seventh of the width (i) of the trough (18).

2) The element according to claim 1, wherein the outer transit zone (19) has a width (r) which is greater than a tenth of the width (i) of the trough (18), and/or a width (r) which is greater than 0.6 mm.

3) The element according to claim 1, wherein the respective engagement trough comprises a first face (181) and a second face (182) opposite each other, for engaging a corresponding surface of the screwing and/or unscrewing means, the engagement faces (182, 182) being recessed relative to the outer profile and converging towards and at a respective radially inner zone (180) of common convergence of the self-same faces (181, 182) of the trough (18); the respective face (181, 182) of the respective trough (18) being separated from the respective face (181, 182) of the adjacent trough (18) of the engagement means (16) through the outer perimeter transit zone (19).

4) The element according to claim 1, wherein the engagement means (16) comprise seven or more engagement troughs (18), in particular between eight and fourteen troughs, more particularly between eight and twelve troughs and, preferably, ten troughs (18).

5) The element according to claim 1, wherein the respective trough (18) has a maximum radial thickness, or maximum depth (p) which is between 0.5 mm and 2 mm, in particular between 0.6 mm and 2 mm, and preferably between 0.8 mm and 2 mm.

6) The element according to claim 3, wherein the respective face (181, 182) of the engagement trough (18) is flat and extends perpendicularly, in particular extending perpendicularly for a distance greater than at least ten times the width of the engagement face itself.

7) The element according to claim 3, wherein the faces (181, 182) of each trough are angularly spaced from each other by an angle (A) of between 135° and 154°, in particular between 135° and 150° and, preferably, an angle equal to or around 144°.

8) The element according to claim 3, wherein the zone of common convergence (180) of the engagement faces (181, 182) of the trough (180) is defined by a linear, perpendicular transit stretch (180).

9) The element according to claim 1, wherein the respective outer transit zone (19) between adjacent troughs (18) has a large circular profile.

10) The element according to claim 1, wherein the height (h) of the engagement means (16) or of the engagement troughs (18) is greater than the diameter of the outer imaginary perimeter of the engagement means themselves, in particular greater than twice the diameter.

11) The element according to claim 1, comprising a shank (121) which extends from the head (120) of the element, or bolt, the shank having, along at least part of its peripheral profile, a corresponding thread (122).

12) The element according to claim 1, wherein, on the side of the body (12) of the element which defines the engagement surface (16), there extends perpendicularly an extension block (24) whose outer profile extends on the outside of the outer profile of the engagement means (16), that is, outside the imaginary outer perimeter thereof.

13) The element according to claim 12, wherein the extension block (24) has a cylindrical portion (125) which is adjacent to the zone defining the engagement means (16) and from which a portion (126) with a conical outside surface extends perpendicularly and wherein the extension block (24) is longitudinally delimited by a transverse surface (160) at the base of the engagement means or surface (16).

14) The element according to claim 1, wherein the body (12) of the element or nut has an internal cavity (13) delimited by a perimeter wall (130) of the body of the element, the inside surface of which (131) is provided with a respective thread (132) and wherein the radial thickness (s) of the hollow body (12) of the element (100, 100′), between the radially inner zone (180) of common convergence of the faces (181, 182) of the trough (18) and the bottom of the thread (131), is between 1.5 mm and 2.5 mm, preferably equal to or around 2 mm.

15) The element according to claim 14, wherein the internal cavity (13) is blind, that is to say, it extends perpendicularly between an open end and a transverse closed end wall (13′), and wherein the transverse closed end wall (13′) is made as one piece with the side wall (13) of the body (12) of the element or nut, that is to say, with the other parts of the nut body, the nut body (12) being in particular made by cold forming a respective block.

16) A tool or spanner (200) for the screwing and unscrewing of connecting elements, in particular of a bolt or a nut, preferably for fastening a wheel, or rim, to a hub of a vehicle, especially of a motor vehicle such as a motor car; comprising a body (212) having respective means (216) for engaging corresponding engagement means (16) of the connecting element; and engagement means (220) for actuating the tool in rotation; the engagement means (216) comprising a plurality of perpendicularly extending and circumferentially distributed engagement troughs (218), these engagement troughs (218) projecting inwards towards the center of the tool, starting from a corresponding imaginary bottom profile (214) and each being separated from the adjacent trough (218) by a respective perimetrically extending transit zone (219);
characterized in that the width (r) of the transit zone (219) between adjacent engagement troughs (218, 218) is less than the width (i) of the respective trough (218), in particular the width (r) of the transit zone (219) being less than half the width (i) of the trough (218), and more particularly, the width (r) of the transit zone (219) being less than a quarter of the width (i) of the trough (218); the width (r) of the transit zone (219) being preferably less than a sixth of the width (i) of the trough (218) and still more preferably, the width (r) of the transit zone (219) being less than a seventh of the width (i) of the trough (218).

17) The tool according to claim 16, characterized in that the transit zone (219) has a width (r′) which is greater than a tenth of the width (i) of the trough (218), and/or a width (r′) which is greater than 0.6 mm.

18) The tool according to claim 16, wherein the respective engagement trough comprises a first face (281) and a second face (282) opposite each other, for engaging a corresponding surface of the connecting element, the engagement faces (282, 282) projecting inwards relative to the imaginary bottom profile of the engagement means (216) and converging towards and at a respective radially inner zone (280) of common convergence of the self-same faces (281, 282) of the trough (218); the respective face (281, 282) of the respective trough (218) being separated from the respective face (281, 282) of the adjacent trough (218) of the engagement means (216) through the perimeter transit zone (219).

19) The tool according to claim 16, wherein the engagement means (216) comprise seven or more inwardly protruding engagement troughs (218), in particular between eight and fourteen inwardly protruding troughs (218), more particularly between eight and twelve inwardly protruding troughs (218) and, preferably, ten inwardly protruding troughs (218).

20) The tool according to claim 16, wherein the respective trough (218) has a maximum radial thickness (p′) which is between 0.5 mm and 2 mm, in particular between 0.6 mm and 2 mm, and preferably between 0.8 mm and 2 mm.
